(19) United States
(12) Patent Application Publication
(10) Pub. No.: US 2024/0364442 A1
(43) Pub. Date: Oct. 31, 2024

(54) SEMICONDUCTOR DEVICE AND ELECTRONIC APPLIANCE

(71) Applicant: ROHM CO., LTD., Kyoto (JP)

(72) Inventor: Kei NAGAO, Kyoto (JP)

(21) Appl. No.: 18/769,462

(22) Filed: Jul. 11, 2024

Related U.S. Application Data
(63) Continuation of application No. PCT/JP2022/045461, filed on Dec. 9, 2022.

(30) Foreign Application Priority Data
Jan. 19, 2022 (JP) 2022-006120

(51) Int. Cl. H04J 3/06; H04L 7/04

(52) U.S. Cl. CPC H04J 3/0673; H04L 7/044

(57) ABSTRACT

A semiconductor device is used as one of a plurality of slaves connected in multiple stages to a master and transmits a frame signal output from the master sequentially from a preceding stage to a subsequent stage. The frame signal includes synchronization bits and a message string (for example, command bits, address bits, and guard bits) following the synchronization bits. The semiconductor device includes a logic circuit configured to sample the frame signal at a baud rate corresponding to the synchronization bits and an output stage configured to through-outputs the synchronization bits before sampling without passing them through the logic circuit.

### CROSS-REFERENCE TO RELATED APPLICATIONS

This nonprovisional application is a continuation application of International Patent Application No. PCT/JP2022/045461 filed on Dec. 9, 2022, which claims priority Japanese Patent Application No. 2022-006120 filed on Jan. 19, 2022, the entire contents of which are hereby incorporated by reference.

### TECHNICAL FIELD

The disclosure herein relates to a semiconductor device and an electronic appliance incorporating a semiconductor device.

### BACKGROUND ART

Semiconductor devices having a serial communication function are used in various applications.

One example of known technology related to what has just been mentioned is seen in Patent Document 1 identified below.

### CITATION LIST

### Patent Literature

Patent Document 1: JP-A-H06-177940

### BRIEF DESCRIPTION OF DRAWINGS

FIG. 1 is a diagram showing one configuration example of an electronic appliance.

FIG. 2 is a diagram showing an example of the data configuration of a frame signal.

FIG. 3 is a diagram showing an example of accumulation of sampling errors.

FIG. 4 is a diagram showing through-output operation for synchronization bits (first embodiment).

FIG. 5 is a diagram showing an example of eliminating the accumulation of sampling errors.

FIG. 6 is a diagram showing a configuration of a principal portion of the semiconductor device (second embodiment).

FIG. 7 is a diagram showing how sampling errors accumulate.

FIG. 8 is a diagram showing how the accumulation of sampling errors is eliminated.

### DESCRIPTION OF EMBODIMENTS

### <Electronic Appliance>

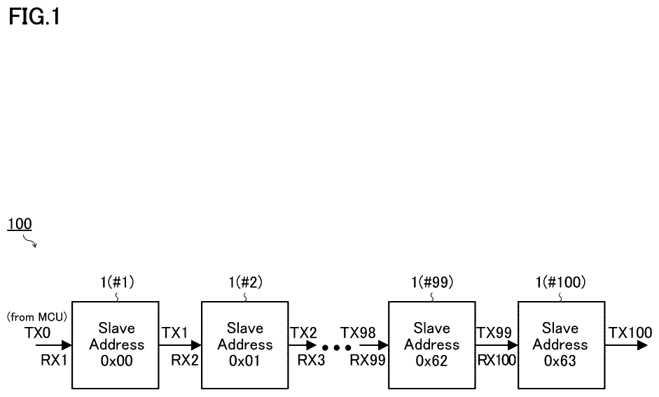

FIG. 1 is a diagram showing one configuration example of an electronic appliance. The electronic appliance 100 of this configuration example includes a plurality of semiconductor devices 1 (for example, a maximum of 100 semiconductor devices 1 (#1 to #100)) as a plurality of slaves that are connected in multiple stages (cascade connected) to an unillustrated master. Suitably used as the master is, for example, an MCU (micro control unit).

In conformity with an asynchronous serial communication protocol (such as UART [universal asynchronous receiver transmitter]), the semiconductor devices 1 (#1 to #100) serially transmit, from a preceding stage to a subsequent stage sequentially, a frame signal output from the master.

In terms of what is shown in the diagram, the semiconductor device 1 (#1) receives, as a reception signal RX1 one bit at a time, a transmission signal TX0 that is transmitted one bit at a time from the preceding master, while transmitting a transmission signal TX1 one bit at a time to the subsequent semiconductor device 1 (#2). Similarly, the semiconductor device 1 (#2) receives, as the reception signal RX2 one bit at a time, the transmission signal TX1 that is transmitted one bit at a time from the preceding semiconductor device 1 (#1), while transmitting a transmission signal TX2 one bit at a time to the subsequent semiconductor device 1 (#3). More generally put, the semiconductor device 1 (#m) (where m=1, 2, . . . , 100) receives, as the reception signal RXm one bit at a time, the transmission signal TX (m−1) that is transmitted one bit at a time from the preceding stage, while transmitting a transmission signal TXm one bit at a time to the subsequent stage.

The semiconductor devices 1 (#1 to #100) may be given slave addresses that increment by one (in this diagram, from 0x00 to 0x63).

### <Frame Signal>

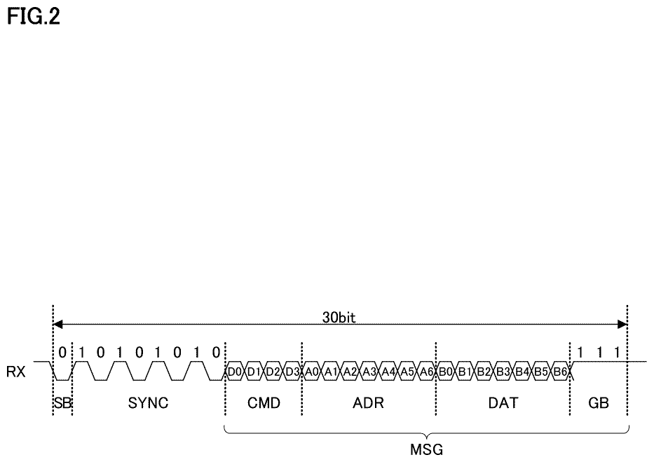

FIG. 2 is a diagram showing an example of the data configuration of a reception signal RX in the semiconductor device 1. The reception signal RX in FIG. 2 is a multi-bit (e.g., 30-bit) frame signal used in asynchronous serial communication such as UART and includes, from head to tail, a start bit SB, synchronization bits SYNC, command bits CMD, address bits ADR, data bits DAT, and guard bits GB.

The start bit SB is a bit signal (e.g., 1 bit) used to notify the semiconductor device 1 of the start of asynchronous serial communication.

The synchronization bits SYNC are a bit signal (e.g., 8 bits, “10101010b” in the diagram) used to set the baud rate in the semiconductor device 1. The baud rate is a value indicating how many times digital data can be modulated in one second. For example, in serial communication in which one bit of digital data is transmitted per modulation, the baud rate can be understood as a value indicating communication speed (given in bps [bits per second]).

The command bits CMD, are for example, a bit signal (e.g., 4 bits) used to transmit a write or read command to the semiconductor device 1. The command bits CMD, as shown in the diagram, may be transmitted and received sequentially starting with the least significant bit LSB (D0→D1→D2→D3).

The address bits ADR are a bit signal (e.g., 7 bits) used to transmit the slave address to the semiconductor device 1. The address bits ADR, as shown in the diagram, may be transmitted and received sequentially starting with the least significant bit LSB (A0→A1→ . . . →A5→A6).

The data bits DAT are a bit signal (e.g., 7 bits) used to transmit data to the semiconductor device 1. The data bits DAT, as shown in the diagram, may be transmitted and received sequentially starting with the least significant bit LSB (B0→B1→ . . . →B5→B6).

The guard bits GB are a dummy bit (e.g., 3 bits, “111b” in the diagram) used to prevent an overrun error.

Among the packet elements described above, the command bits CMD, the address bits ADR, the data bits DAT, and the guard bits GB may be understood as a message string MSG following the synchronization bits SYNC.

### <Discussion on Accumulation of Sampling Errors>

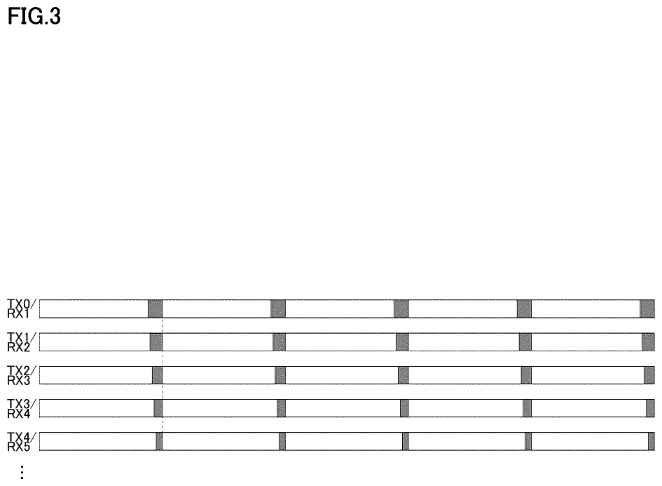

FIG. 3 is a diagram showing an example of accumulation of sampling errors in multi-stage connection of semiconductor devices 1 (the semiconductor devices 1 (#1 to #4) are assumed in the diagram). FIG. 3 depicts, from top down, the transmission signal TX0/the reception signal RX1, the transmission signal TX1/the reception signal RX2, the transmission signal TX2/the reception signal RX3, the transmission signal TX3/the reception signal RX4, and the transmission signal TX4/the reception signal RX5. The hatched parts in the diagram represent the guard bits GB, while the hollow parts represent the packet elements other than the guard bits GB (i.e., the start bit SB, the synchronization bits SYNC, the command bits CMD, and the data bits DAT).

The transmission signals TX1 to TX4 of the semiconductor devices 1 (#1 to #4) include the sampling errors in the semiconductor devices 1 (#1 to #4) respectively. In particular, in a configuration where the synchronization bits SYNC of each of the reception signals RX1 to RX4 are sequentially sampled by the semiconductor devices 1 (#1 to #4) and transmitted to the subsequent stages, the sampling errors in the preceding stages accumulate as stages proceed.

That is, in the semiconductor device 1 (#i) (where i=2, 3, 4) in the second or any subsequent stage, the transmission signal TXi includes not only the sampling errors in the semiconductor device 1 (#i) itself but also the sampling errors in the semiconductor devices 1 (#1 to #(i−1)) provided in the stages preceding the semiconductor device 1 (#1).

On the other hand, the transmission signals TX1 to TX4 have the same output timing because it coincides with the arrival timing of the start bit SB. Thus, as shown in the diagram, the guard bits GB becomes shorter as stages proceed, and this increases the risk of an overrun error.

For example, suppose the baud rate is 100 kbps, the operation clock frequency is 1.8 MHz, and the sampling error is 2 clk/4 bits (that is, 12 clk/frame); then the accumulated value of the sampling error in the semiconductor device 1 (#100) in the 100th stage is 1200 clk (12×100). Thus, even with the 3-bit (54-clk) guard bits GB, an overrun error may occur.

Increasing the number of bits in the guard bits GB can prevent an overrun error, but leads to a drop in the communication speed in the entire system.

In view of the discussion above, the following description presents a novel semiconductor device that can eliminate the accumulation of sampling errors in multi-stage connection.

### <Semiconductor Device (First Embodiment)>

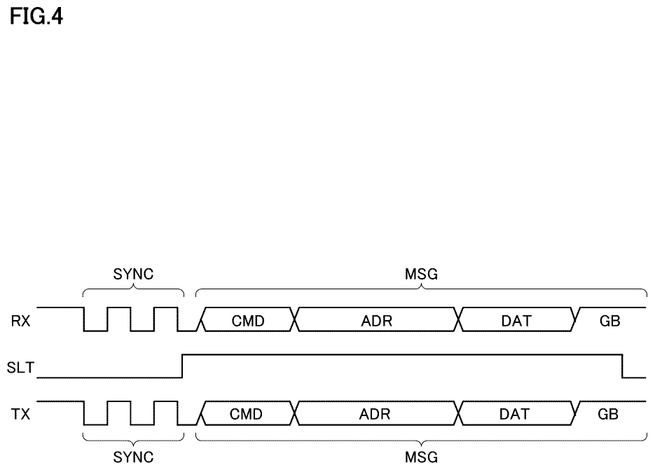

FIG. 4 is a diagram showing the through-output operation for the synchronization bits SYNC in the semiconductor device 1 of the first embodiment, illustrating, from top down, the reception signal RX, the selection signal SLT, and the transmission signal TX.

The semiconductor device 1 of this embodiment, when a selection signal SLT (details will be given later) is at a low level, does not sample and through-outputs (i.e., outputs as it is) the synchronization bits SYNC in the reception signal RX as the transmission signal TX. In the semiconductor device 1 of this embodiment, when the selection signal SLT is at high level, samples and then outputs the message string MSG (the command bits CMD, the address bits ADR, the data bits DAT, and the guard bits GB) of the reception signal RX as the transmission signal TX.

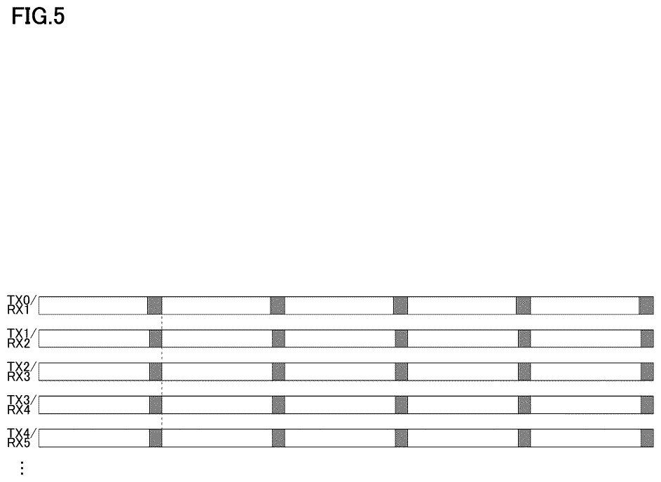

FIG. 5 is a diagram showing an example of eliminating the accumulation of sampling errors in multi-stage connection of semiconductor devices 1 (the semiconductor devices 1 (#1 to #4) in the diagram). FIG. 5 depicts, like FIG. 3 referred to previously, from top down, the transmission signal TX0/the reception signal RX1, the transmission signal TX1/the reception signal RX2, the transmission signal TX2/the reception signal RX3, the transmission signal TX3/the reception signal RX4, and the transmission signal TX4/the reception signal RX5. The hatched parts in the diagram represent the guard bits GB, while the hollow parts represent the packet elements other than the guard bits GB (i.e., the start bit SB, the synchronization bits SYNC, the command bits CMD, and the data bits DAT).

As described above, the semiconductor devices 1 (#1 to #4) of this embodiment through-outputs, without sampling, the synchronization bits SYNC for setting the baud rate to the subsequent stage. Thus, even as stages proceed, sampling errors from the preceding stages do not accumulate. As a result, even when the semiconductor devices 1 (#1 to #4) are connected in multiple stages, the guard bits (GB) do not become shorter, and this makes an overrun error less likely. Here, the semiconductor devices 1 (#1 to #4) each have a sampling error which arises from the MCU pattern.

### <Semiconductor Device (Second Embodiment)>

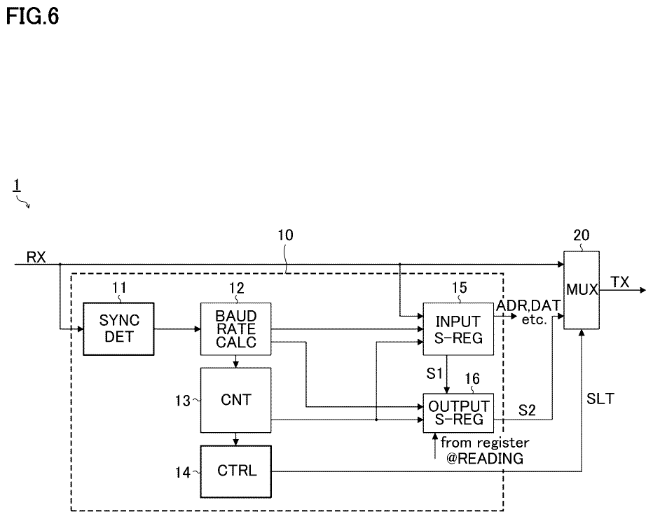

FIG. 6 is a diagram showing a configuration of a principal portion of the semiconductor device 1 according to a second embodiment (an internal configuration example for implementing the first embodiment described above). As shown in FIG. 6, the semiconductor device 1 of this embodiment includes a logic circuit 10 and an output stage 20.

The logic circuit 10 samples the reception signal RX at a baud rate corresponding to the synchronization bits SYNC and controls the output of the transmission signal TX in the output stage 20. In terms of what is shown in FIG. 6, the logic circuit 10 includes a synchronization bit detector 11, a baud rate calculator 12, a counter 13, a controller 14, an input shift register 15, and an output shift register 16.

The synchronization bit detector 11 detects the synchronization bits SYNC from the reception signal RX.

The baud rate calculator 12 calculates the baud rate (and hence the sampling timing, the output timing, etc.) based on the synchronization bits SYNC detected by the synchronization bit detector 11.

The counter 13 performs counting operation based on the output signal (that is, the baud rate) of the baud rate calculator 12 to control various timings (such as the sampling timing and the output timing).

The controller 14 controls the output stage 20 by switching the logic level of the selection signal SLT according to the output signal (that is, the output timing control signal) of the counter 13.

For example, the controller 14 switches the logic level of the selection signal SLT to output, during the output period of the synchronization bits SYNC, the reception signal RX as it is as the transmission signal TX and, during the output period of the message string MSG following the synchronization bits SYNC, a second signal S2 (details will be given later) obtained by sampling in the logic circuit 10 as the transmission signal TX.

More specifically, the controller 14, during the output period of the synchronization bits SYNC, keeps the selection signal SLT at low level and, during the output period of the message string MSG, keeps the selection signal SLT at high level (see FIG. 4 referred to previously).

The input shift register 15 (corresponding to a first register) samples the reception signal RX according to the output signal (baud rate) of the baud rate calculator 12 and the output signal (sampling timing control signal) of the counter 13. Then, the input shift register 15 outputs the reception signal RX after sampling as a first signal S1 to the output shift register 16. The input shift register 15 outputs, out of the reception signal RX after sampling, information needed for the semiconductor device 1 to operate (such as address bits ADR and data bits DAT) to the internal circuit (not shown) of the semiconductor device 1.

The output shift register 16 (corresponding to a second register) samples the first signal S1 according to the output signal (the baud rate) of the baud rate calculator 12 and the output signal (the sampling timing control signal) of the counter 13. The output shift register 16 outputs the first signal S1 after sampling as the second signal S2 to the output stage 20. When a read command is fed to the semiconductor device 1, a signal value read from an internal register (not shown) is stored in the output shift register 16 and is then output as the second signal S2 to the output stage 20.

The output stage 20 is a multiplexer configured to, depending on an instruction from the controller 14 (i.e., the selection signal SLT), output either the reception signal RX or the second signal S2 as the transmission signal TX. For example, the output stage 20, when the selection signal SLT is at low level, selects and outputs the reception signal RX as the transmission signal TX and, when the selection signal SLT is at high level, selects and outputs the second signal S2 as the transmission signal TX.

That is, the output stage 20, during the output period of the synchronization bits SYNC, outputs the reception signal RX as it is as the transmission signal TX and, during the output period of the message string MSG following the synchronization bits SYNC, outputs the second signal S2 obtained through sampling in the logic circuit 10 as the transmission signal TX.

In this way, the output stage 20, based on the selection signal SLT generated in the logic circuit 10, through-outputs the synchronization bits SYNC before sampling without passing them through the logic circuit 10, and subsequently outputs a message string MSG after sampling.

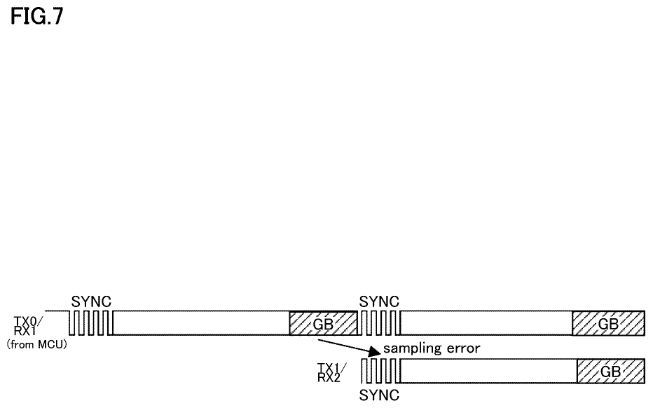

FIG. 7 is a diagram showing (as a comparative example to be compared with this embodiment) how sampling errors accumulate if the synchronization bits SYNC are not through-output in the semiconductor device 1 (the first-stage semiconductor device 1 (#1) is assumed in the diagram). If, for the sake of discussion, the synchronization bits SYNC after sampling in the reception signal RX1 is output to the subsequent stage, the synchronization bits SYNC in the transmission signal TX1 include a sampling error.

For example, consider a case where, due to sampling errors in the semiconductor device 1 (#m) (where m=1, 2, . . . , 100), the synchronization bits SYNC of the reception signal RX (m+1) in the semiconductor device 1 (#m+1) becomes 1.01 times as long as the synchronization bits SYNC in the reception signal RXm in the semiconductor device 1 (#m).

In this case, the synchronization bits SYNC in the reception signal RX100 in the semiconductor device 1 (#100) becomes approximately 2.70 times (=1.01¹⁰⁰) as long as the synchronization bits SYNC in the reception signal RX1 in the semiconductor device 1 (#1). Thus, to avoid an overrun error, it is necessary to makes the guard bits GB sufficiently long, and this leads to a drop in the communication speed.

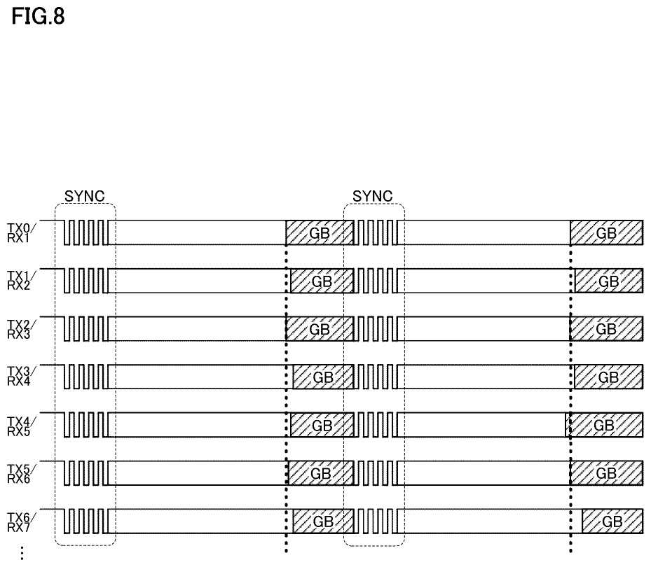

FIG. 8 is a diagram showing how the accumulation of sampling errors is eliminated by through-outputting the synchronization bits SYNC in the semiconductor device 1 (semiconductor devices 1 (#1 to #7) are assumed in the diagram) of the second embodiment. FIG. 8 depicts, from top down, the transmission signal TO/the reception signal RX1, the transmission signal TX1/the reception signal RX2, the transmission signal TX2/the reception signal RX3, the transmission signal TX3/the reception signal RX4, the transmission signal TX4/the reception signal RX5, the transmission signal TX5/the reception signal RX6, and the transmission signal TX6/the reception signal RX7. The pulse parts in the diagram represent the synchronization bits SYNC and the hatched parts represent the guard bits GB. The hollow parts represent the packet elements other than the synchronization bits SYNC and the guard bits GB (i.e., the command bits CMD and the data bits DAT).

As described above, the semiconductor devices 1 (#1 to #7) of the second embodiment through-outputs, without sampling, the synchronization bits SYNC for setting the baud rate to the subsequent stage. That is, as indicated in broken-line frame in the diagram, the synchronization bits SYNC in each of the reception signals RX1 to RX7 have the same length, and, even as stages proceed, sampling errors from the preceding stages do not accumulate. Thus, even when the semiconductor devices 1 (#1 to #7) are connected in multiple stages, the guard bits GB do not become shorter, and this makes an overrun error less likely.

### <Overview>

To follow is an overview of the various embodiments described above.

For example, according to one aspect of what is disclosed herein, a semiconductor device is used as one of a plurality of slaves connected in multiple stages to a master. The semiconductor device is configured to transmit a frame signal output from the master sequentially from a preceding stage to a subsequent stage. The frame signal includes synchronization bits and a message string following the synchronization bits. The semiconductor device includes: a logic circuit configured to sample the frame signal at a baud rate corresponding to the synchronization bits; and an output stage configured to through-outputs the synchronization bits before sampling without passing the synchronization bits through the logic circuit. (A first configuration.)

In the semiconductor device according to the first configuration described above, preferably, the output stage outputs the message string after sampling so as to follow the synchronization bit before sampling. (A second configuration.)

In the semiconductor device according to the second configuration described above, preferably, the logic circuit includes: a synchronization bit detector configured to detect the synchronization bits from the frame signal input as a reception signal; a baud rate calculator configured to calculate the baud rate from the synchronization bits; a counter configured to control the timing based on the baud rate; a controller configured to control the output stage; a first register configured to receive the reception signal to output a first signal; and a second register configured to receive the first signal to output a second signal. (A third configuration.)

In the semiconductor device according to the third configuration described above, preferably, the output stage is a multiplexer configured to output one of the reception signal and the second signal as a transmission signal according to an instruction from the controller. (A fourth configuration.)

In the semiconductor device according to the fourth configuration described above, preferably, the controller is configured to control the multiplexer so as to output, as the transmission signal, the reception signal during the output period of the synchronization bits and the second signal during the output period of the message string. (A fifth configuration.)

In the semiconductor device according to any of the first to fifth configurations described above, preferably, the message string includes command bits, address bits, data bits, and guard bits. (A sixth configuration.)

For example, according to another aspect of what is disclosed herein, an electronic appliance includes the semiconductor devices according to any of the first to sixth configurations described above as each of a plurality of slaves connected in multiple stages to a master. (A seventh configuration.)

According to the invention disclosed herein, it is possible to provide a semiconductor device that can eliminate accumulation of sampling errors in multi-stage connection and also to provide an electronic appliance incorporating such a semiconductor device.

### <Further Modifications>

The various technical features disclosed herein may be implemented in any other manners than in the embodiments described above, and allow for any modifications made without departure from their technical ingenuity. That is, the embodiments described above should be considered to be illustrative in all respects and should not be considered to be restrictive. It should be understood that the technical scope of the present invention is defined by the scope of claims and encompasses any modifications made in a scope and sense equivalent to the scope of claims.

1. A semiconductor device used as one of a plurality of slaves connected in multiple stages to a master, the semiconductor device being configured to transmit a frame signal output from the master sequentially from a preceding stage to a subsequent stage,
wherein
the frame signal includes synchronization bits and a message string following the synchronization bits, and
the semiconductor device includes:
a logic circuit configured to sample the frame signal at a baud rate corresponding to the synchronization bits; and
an output stage configured to through-outputs the synchronization bits before sampling without passing the synchronization bits through the logic circuit.

2. The semiconductor device according to claim 1,
wherein
the output stage outputs the message string after sampling so as to follow the synchronization bit before sampling.

3. The semiconductor device according to claim 2,
wherein
the logic circuit includes:
a synchronization bit detector configured to detect the synchronization bits from the frame signal input as a reception signal;
a baud rate calculator configured to calculate the baud rate from the synchronization bits;
a counter configured to control a timing based on the baud rate;
a controller configured to control the output stage;
a first register configured to receive the reception signal to output a first signal; and
a second register configured to receive the first signal to output a second signal.

4. The semiconductor device according to claim 3,
wherein
the output stage is a multiplexer configured to output one of the reception signal and the second signal as a transmission signal according to an instruction from the controller.

5. The semiconductor device according to claim 4,
wherein
the controller is configured to control the multiplexer so as to output, as the transmission signal,
the reception signal during an output period of the synchronization bits and
the second signal during an output period of the message string.

6. The semiconductor device according to claim 1,
wherein
the message string includes command bits, address bits, data bits, and guard bits.

7. An electronic appliance comprising the semiconductor devices according to claim 1 as each of a plurality of slaves connected in multiple stages to a master.
